(19) United States
(12) Patent Application Publication
(10) Pub. No.: US 2025/0372965 A1
(43) Pub. Date: Dec. 4, 2025

(54) CABLE PULLER

(71) Applicant: MILWAUKEE ELECTRIC TOOL CORPORATION, Brookfield, WI (US)

(72) Inventors: Ian C. Richards, Shorewood, WI (US); Caden M. Sinur, West Bend, WI (US); Jesse J. Goudreau, Hartford, WI (US); Evan M. Glanzer, Milwaukee, WI (US); Trevor J. Schwarz, Wauwatosa, WI (US)

(21) Appl. No.: 19/223,463

(22) Filed: May 30, 2025

Related U.S. Application Data
(60) Provisional application No. 63/654,663, filed on May 31, 2024.
(60) Provisional application No. 63/695,625, filed on Sep. 17, 2024.
(60) Provisional application No. 63/697,056, filed on Sep. 20, 2024.
(60) Provisional application No. 63/791,127, filed on Apr. 18, 2025.

(51) Int. Cl. H02G 1/08; B66D 1/12

(52) U.S. Cl. CPC H02G 1/081; B66D 1/12; H02G 1/085

(57) ABSTRACT

A cable puller includes a motor housing and a motor disposed in the motor housing. The motor rotates about a motor axis. The cable puller further includes a capstan assembly rotationally driven by the motor about the motor axis and a handle housing coupled to the motor housing. The handle housing has a battery receptacle for removably receiving a rechargeable battery pack. Moreover, the cable puller includes a boom coupled to the motor housing opposite the handle housing.

### CROSS-REFERENCE TO RELATED APPLICATIONS

This application claims priority to co-pending U.S. Provisional Patent Application No. 63/791, 127, filed Apr. 18, 2025, U.S. Provisional Patent Application No. 63/697,056, filed Sep. 20, 2024, U.S. Provisional Patent Application No. 63/695,625, filed Sep. 17, 2024, and U.S. Provisional Patent Application No. 63/654,663, filed May 31, 2024, the entire contents of all of which are incorporated herein by reference.

### FIELD OF THE DISCLOSURE

The present disclosure relates to tools for pulling wires and cables, and more particularly to battery powered cable pullers.

### BACKGROUND OF THE DISCLOSURE

In the commercial electrical industry, it is frequently required that wires and cables are disposed in conduits, such as pipes. The pipes may be electrical metallic tubing (EMT), galvanized rigid pipe, coated rigid pipe, etc. The pipes are typically provided in ten-foot lengths that are coupled together via threaded couplers, set screw couplers, or compression couplers. To pull a group of wires, or cables, through a long run of conduit, or pipe, a foam conduit piston (or “mouse”) with a light line tied thereto is sucked through the conduit using a vacuum. A rope is tied to the light line and pulled back through the pipe. Then, the wires, or cables, can be braided together to form a pulling head, or installed in a separate pulling head that fits over the wires. The rope is connected to the pulling head and is used to pull the wires, or cables, through the conduit. Liquid soap, or other lubricant, can be used to reduce friction between the wires and the inner wall of the conduit.

The rope may be pulled by hand or with a mechanical tugger, or puller. The electrical industry is always seeking advances in tools to make the installation of wire within conduits quicker and more efficient.

### SUMMARY OF THE DISCLOSURE

In some aspects, the techniques described herein relate to a cable puller including a motor housing; a motor disposed in the motor housing, the motor rotating about a motor axis; a capstan assembly rotationally driven by the motor about the motor axis; a handle housing coupled to the motor housing, the handle housing including a battery receptacle for removably receiving a rechargeable battery pack; and a boom coupled to the motor housing opposite the handle housing.

In some aspects, the techniques described herein relate to a cable puller, wherein the motor housing further includes a plurality of gears disposed therein, the plurality of gears driven by the motor and driving the capstan assembly.

In some aspects, the techniques described herein relate to a cable puller, wherein the handle housing forms a handle, and a plane crosses through the capstan assembly, the motor, and the handle.

In some aspects, the techniques described herein relate to a cable puller, wherein the plane further crosses through the boom.

In some aspects, the techniques described herein relate to a cable puller, wherein the battery receptacle is configured to receive the rechargeable battery pack in an insertion direction, the insertion direction being perpendicular to the motor axis.

In some aspects, the techniques described herein relate to a cable puller, wherein the boom extends along a boom axis, and the boom axis and the motor axis form a boom angle therebetween, the boom angle being greater than or equal to thirty degrees.

In some aspects, the techniques described herein relate to a cable puller, wherein the boom angle is less than or equal to sixty degrees.

In some aspects, the techniques described herein relate to a cable puller, wherein the boom angle is greater than or equal to thirty-five degrees and less than or equal to fifty-five degrees.

In some aspects, the techniques described herein relate to a cable puller, wherein the boom angle is greater than or equal to forty degrees and less than or equal to fifty degrees.

In some aspects, the techniques described herein relate to a cable puller, wherein the boom angle is forty-five degrees.

In some aspects, the techniques described herein relate to a cable puller including: a handle housing including a battery receptacle for removably receiving a rechargeable battery pack; a motor housing coupled to the handle housing and including a motor disposed therein, the motor housing further including a base for engaging a support surface; a capstan assembly disposed on an end of the motor housing opposite the base, the capstan assembly configured to be driven by the motor; and a boom coupled to the motor housing opposite the handle housing.

In some aspects, the techniques described herein relate to a cable puller, wherein the handle housing and the boom are coupled to the motor housing between the base and the end of the motor housing opposite the base.

In some aspects, the techniques described herein relate to a cable puller, wherein the motor housing is generally cylindrical.

In some aspects, the techniques described herein relate to a cable puller, further including a circuit board disposed in the handle housing.

In some aspects, the techniques described herein relate to a cable puller, wherein the circuit board is disposed between the battery receptacle and the motor housing.

In some aspects, the techniques described herein relate to a cable puller, further including a gear assembly disposed between the motor and the capstan assembly.

In some aspects, the techniques described herein relate to a cable puller, wherein the motor rotates about a motor axis that extends through the base, the capstan assembly configured to rotate about the motor axis.

In some aspects, the techniques described herein relate to a cable puller, wherein each of the handle housing, the boom, and the capstan extends beyond the motor housing in a direction away from the base.

In some aspects, the techniques described herein relate to a cable puller, further including a load indicator disposed on the handle housing.

In some aspects, the techniques described herein relate to a cable puller, wherein the battery receptacle is configured to receive the rechargeable battery pack along an insertion direction, and the base is coincident with a plane that is parallel with the insertion direction.

In some aspects, the techniques described herein relate to a cable puller including a motor housing including a motor disposed therein and rotatable about a motor axis; a handle housing coupled to the motor housing; a battery receptacle for removably receiving a rechargeable battery pack; a capstan rotationally driven by the motor about the motor axis such that a rope is wrapped around the capstan during rotation; and a self-tailing mechanism coupled to the capstan, the self-tailing mechanism configured to receive a portion of the rope to reduce tension within the rope.

In some aspects, the techniques described herein relate to a cable puller, wherein the self-tailing mechanism includes a first jaw coupled to the capstan, a second jaw movable relative to the capstan, and a gap defined between the first jaw and the second jaw for receiving the portion of the rope.

In some aspects, the techniques described herein relate to a cable puller, wherein the self-tailing mechanism further includes a tab configured to guide the portion of the rope out of the gap to remove the rope from the self-tailing mechanism.

In some aspects, the techniques described herein relate to a cable puller, wherein the self-tailing mechanism includes a first jaw disposed on the capstan for co-rotation about the motor axis, a second jaw coupled to the capstan for co-rotation, and a fixed gap defined between the first jaw and the second jaw for receiving the portion of the rope.

In some aspects, the techniques described herein relate to a cable puller, wherein the self-tailing mechanism includes a biasing member configured to bias the second jaw toward the first jaw.

In some aspects, the techniques described herein relate to a cable puller, wherein the second jaw includes a first plurality of ribs having a spiral configuration and spaced from each other.

In some aspects, the techniques described herein relate to a cable puller, wherein the first jaw includes a second plurality of ribs having a spiral configuration and spaced from each other.

In some aspects, the techniques described herein relate to a cable puller, wherein the first jaw includes a second plurality of ribs, each rib has a beveled configuration.

In some aspects, the techniques described herein relate to a cable puller, wherein the capstan has a tapered configuration.

In some aspects, the techniques described herein relate to a cable puller including a motor housing including a motor disposed therein and rotatable about a motor axis; a handle housing coupled to the motor housing; a battery receptacle for removably receiving a rechargeable battery pack; and a capstan assembly coupled to the motor housing, the capstan assembly including a capstan rotatably driven by the motor about the motor axis, and a self-tailing mechanism coupled to the capstan and configured to receive a portion of a rope, the self-tailing mechanism including a first jaw and a second jaw oriented relative to each other such at least a portion of the first jaw contacts at least a portion of the second jaw on a first side of the self-tailing mechanism.

In some aspects, the techniques described herein relate to a cable puller, wherein the self-tailing mechanism includes a gap defined between the first jaw and the second jaw on a second side of the self-tailing mechanism opposite the first side.

In some aspects, the techniques described herein relate to a cable puller, wherein the self-tailing mechanism includes a tab disposed on the second side of the self-tailing mechanism, the tab configured to guide the rope into the gap.

In some aspects, the techniques described herein relate to a cable puller including a housing including a motor housing supporting a motor disposed therein and rotatable about a motor axis and a handle housing; a battery receptacle for removably receiving a rechargeable battery pack; and a capstan assembly coupled to the motor housing, the capstan assembly including a capstan rotatably driven by the motor about the motor axis, and a self-tailing mechanism coupled to the capstan and configured to receive a portion of a rope, the self-tailing mechanism including a first jaw and a second jaw movable relative to the first jaw such that a variable gap is defined therebetween for the portion of the rope.

In some aspects, the techniques described herein relate to a cable puller wherein when the portion of the rope has a first diameter, the first jaw and the second jaw are oriented parallel to each other.

In some aspects, the techniques described herein relate to a cable puller wherein when the portion of the rope has a second diameter less than the first diameter, the first jaw and the second jaw are oriented such that the variable gap forms a V-shape.

In some aspects, the techniques described herein relate to a cable puller wherein the battery receptacle is disposed between the motor housing and the handle housing such that the battery receptacle is disposed at a central portion of the housing.

### BRIEF DESCRIPTION OF THE DRAWINGS

FIG. 1 is a perspective view of a cable puller.

FIG. 2 is a side view of the cable puller of FIG. 1.

FIG. 3 is a top view of the cable puller of FIG. 1.

FIG. 4 is a cross-section view of the cable puller of FIG. 1 taken along line 4-4 in FIG. 3.

FIG. 5 is another perspective view of the cable puller of FIG. 1 with the capstan assembly exploded from the central motor housing.

FIG. 6 is a load indicator for the cable puller of FIG. 1.

FIG. 7 is an enlarged view of the cable puller of FIG. 1, the cable puller including a self-tailing mechanism.

FIG. 8 is a cross-section view of the self-tailing mechanism of FIG. 7.

FIG. 9 is a front view of a cable puller according to another embodiment.

FIG. 10 is a top view of the cable puller of FIG. 9 including a capstan assembly.

FIG. 11 is a perspective view of a capstan assembly according to another embodiment.

FIG. 12 is a perspective view of a capstan of the capstan assembly of FIG. 11.

FIG. 13 is an enlarged view of a self-tailing mechanism of the capstan assembly of FIG. 11.

FIG. 14 is an enlarged view of the self-tailing mechanism of the capstan assembly of FIG. 11 with portions transparent.

FIG. 15 is a front view of a bottom jaw of the self-tailing mechanism of FIG. 13.

FIG. 16 is a bottom perspective view of a top jaw the self-tailing mechanism of FIG. 13.

FIG. 17 is a front view of the capstan assembly of FIG. 11 wrapped with a rope.

FIG. 18 is a perspective view of a capstan according to another embodiment.

FIG. 19 is a perspective view of a bottom jaw according to another embodiment.

FIG. 20 is a perspective view of a capstan assembly according to another embodiment.

FIG. 21 is an enlarged view of the capstan assembly of FIG. 20.

FIG. 22 is another enlarged view of the capstan assembly of FIG. 20.

FIG. 23 is a perspective view of a cable puller according to another embodiment.

FIG. 24 is a front view of the cable puller of FIG. 23.

FIG. 25 is a front perspective view of a cable puller according to another embodiment, the cable puller including a capstan assembly.

FIG. 26 is a rear perspective view of the cable puller of FIG. 25.

FIG. 27 is a side view of the capstan assembly of FIG. 25 including a capstan and a self-tailing mechanism.

FIG. 28 is a top perspective view of the capstan of FIG. 27.

FIG. 29A is a top perspective view of a bottom jaw of the self-tailing mechanism of FIG. 27.

FIG. 29B is a bottom perspective view of the bottom jaw of FIG. 29A.

FIG. 30A is a bottom perspective view of a top jaw of the self-tailing mechanism of FIG. 27.

FIG. 30B is a top perspective view of the top jaw of FIG. 30A.

FIG. 31 is a perspective view of the bottom jaw of FIG. 29A and the top jaw of FIG. 30A.

FIG. 32 is a cross-sectional view of the bottom jaw of FIG. 29A and the top jaw of FIG. 30A.

FIG. 33 is an enlarged side view of the self-tailing mechanism of FIG. 27 with portions removed.

FIG. 34 is an enlarged perspective view of the cable puller of FIG. 25 with a rope.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

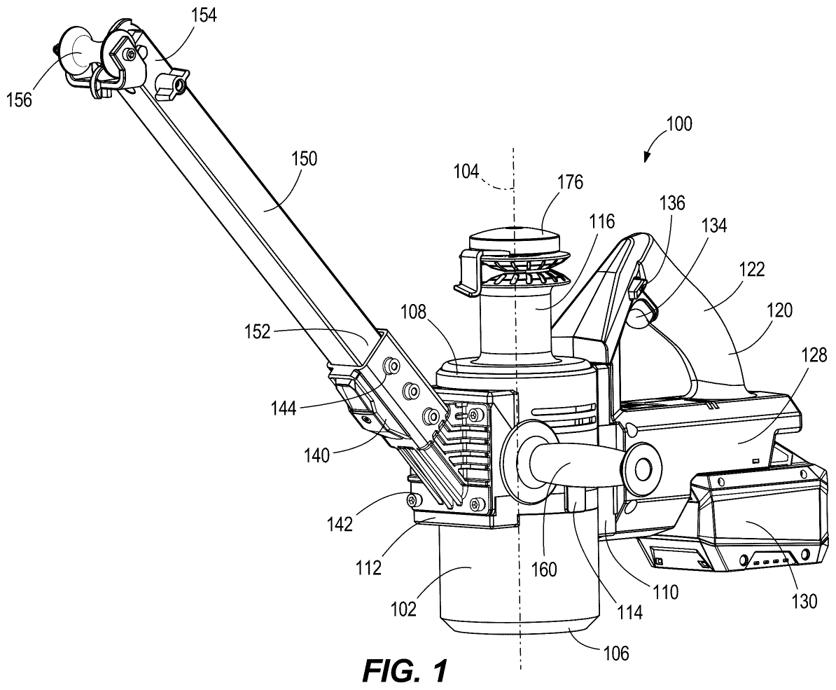

FIGS. 1 through 6 illustrate the details of a cable puller 100 that is used to pull cables and/or wires through enclosed conduits. The cable puller 100 includes a central motor housing 102 that defines a motor axis 104 longitudinally through the center of the central motor housing 102. The central motor housing 102 includes a bottom end (or base) 106, upon which the cable puller 100 may be placed on a support surface, and a top end 108. In the illustrated embodiment, the central motor housing 102 is generally cylindrical, and the base 106 is a generally circular face of the cylindrical motor housing 102. The central motor housing 102 includes a handle housing flange 110 on a first side and a boom support flange 112 on a second side opposite the handle housing flange 110. The handle housing flange 110 and the boom support flange 112 extend partially along the length of the central motor housing 102 from the top end 108 toward the bottom end 106 parallel to the motor axis 104. The cable puller 100 also includes a speed selector 114 between the handle housing flange 110 and the boom support flange 112. The speed selector 114 may be moved up or down between two or more positions in order to change the gearing of a transmission (discussed in more detail below) within the central motor housing 102. The cable puller 100 also includes a capstan assembly 116 (may also be referred to as capstan) that extends from the top end 108 of the central motor housing 102. A motor 118 is disposed in the central motor housing 102 and drives the capstan assembly 116 about the motor axis 104. In the illustrated embodiment, the motor 118 is disposed in a bottom portion of the central motor housing 102, or a half of the central motor housing 102 that is the farthest from the capstan assembly 116.

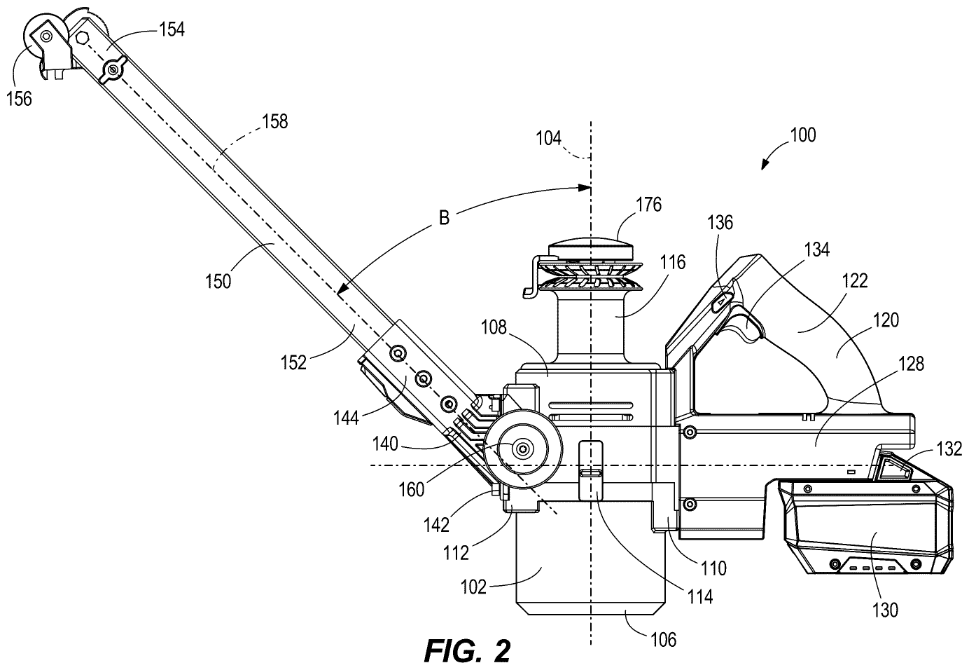

As shown, a handle housing 120 is attached to the handle housing flange 110 and includes a handle 122 configured to be grasped by a user to easily transport the cable puller 100. In the illustrated embodiment, the handle housing 120 is formed as a clamshell housing of two mirrored housing parts joined together. The handle housing 120 also includes a battery receptacle 128 to which a battery pack 130 is removably engaged. In one example, the battery pack 130 includes one or more cell strings and each cell string includes a number of battery cells (e.g., 10) connected in series to provide a desired discharge output (e.g., nominal voltage [e.g., 20 V, 40 V, 60 V, 80 V, 130 V] and current capacity). The battery cells of the battery pack 130 are any rechargeable battery cell chemistry type, such as, for example, lithium (Li), lithium-ion (Li-ion), other lithium-based chemistry, nickel-cadmium (NiCd), nickel-metal hydride (NiMH), etc. The battery pack 130 is slidable along a battery axis 132 (shown in FIG. 2) in a first direction (or insertion direction), toward the motor axis 104, to be engaged with the battery receptacle 128 and in a second direction, away from the motor axis 104 (and opposite the first direction, to be removed from the battery receptacle 128). As shown in FIG. 2, the battery axis 132 is perpendicular to the motor axis 104. In other words, the battery axis 132 is oriented at a right angle) (90° with respect to the motor axis 104. As such, the battery pack 130 is configured to supply power to the motor 118 to drive the capstan assembly 116. FIG. 2 further shows that the handle housing 120 includes a trigger 134 and a trigger lock 136. The trigger 134 is toggled to actuate a motor within the central motor housing 102. In other embodiments, the trigger 134 may control a rotational direction of the capstan assembly 116.

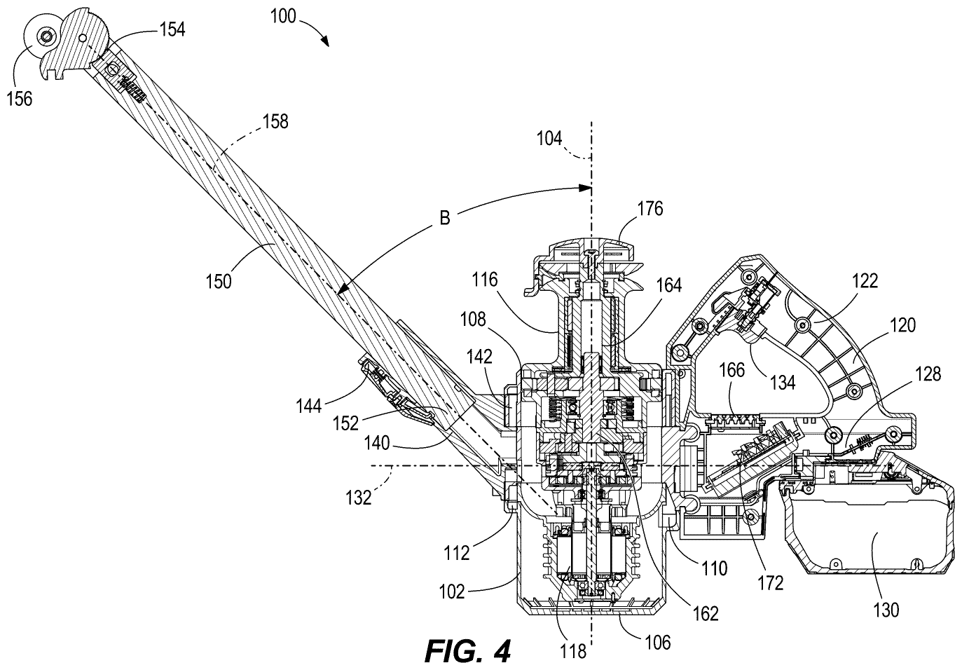

As illustrated in FIGS. 1-5, the cable puller 100 further includes a boom support 140 that is coupled to the boom support flange 112. The boom support 140 includes a base plate 142 and a collar 144 extending therefrom. A boom 150 is disposed within the boom support 140 and includes a first end 152 coupled to the boom support 140 and a second end 154 opposite the first end 152. A roller assembly 156 is coupled to the second end 154 of the boom 150. A shown in FIGS. 2 and 4, the boom support 140 is angled with respect to the motor axis 104 and supports the boom 150 such that it extends along a boom axis 158 that forms a boom angle B with respect to the motor axis 104. The boom angle B is greater than or equal to thirty degrees (30°), such as greater than or equal to thirty-five degrees (35°), greater than or equal to forty degrees (40°), or greater than or equal to forty-five degrees (45°). In another aspect, the boom angle B is less than or equal to sixty degrees (60°), such as less than or equal to fifty-five degrees (55°), or less than or equal to fifty degrees (50°). It is to be understood that the boom angle B may be within a range between and including any of the minimum and maximum values for the boom angle B disclosed herein.

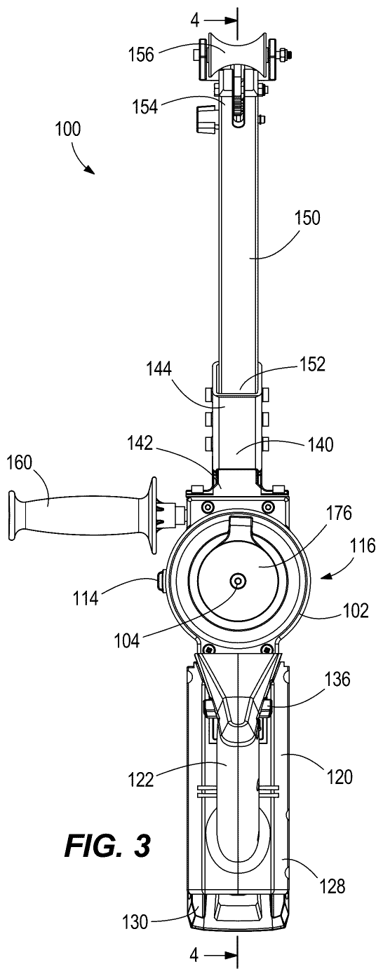

As shown in FIGS. 2 and 4, the capstan assembly 116 extends upwardly from the central motor housing 102. In the illustrated embodiment, the rotational axis of the capstan assembly 116 extends parallel to the motor axis 104. Further, the rotational axis of the capstan assembly 116 extends colinear with the motor axis 104. With reference to FIGS. 1 and 3, an auxiliary handle 160 extends outwardly from the central motor housing 102 and more particularly from the boom support flange 112 in the illustrated embodiment. The auxiliary handle 160 extends along its length in a direction that forms skew lines with the rotational axis of the capstan assembly 116. In the illustrated embodiment, the length of the auxiliary handle 160 lies in a plane that is perpendicular to the rotational axis of the capstan assembly 116.

With reference to FIG. 4, the cable puller 100 further includes a plurality of gears 162, in particular a planetary gear assembly, disposed between the motor 118 and the capstan assembly 116. As shown in FIG. 4, a single plane (the plane of the page of FIG. 4) crosses through the capstan assembly 116, the motor 118, the handle 122, the boom 150, and at least some of the gears 162.

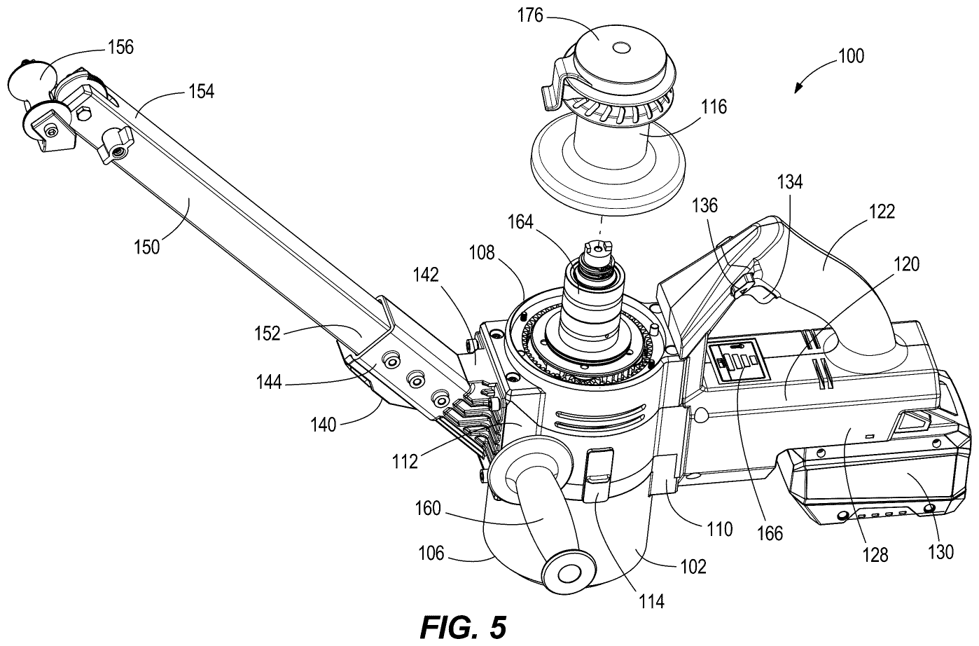

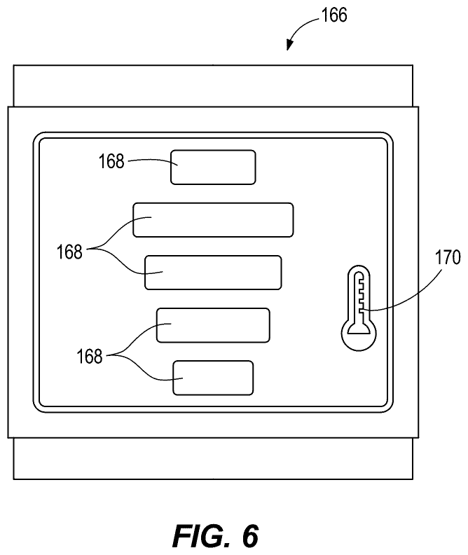

Turning to FIG. 5, a driveshaft 164 extends from the plurality of gears 162 and receives the capstan assembly 116 thereon. Also shown in FIG. 5, the cable puller 100 further includes a load indicator 166 disposed on the handle housing 120. The load indicator 166 is disposed under the handle 122 in particular. In the illustrated embodiment, the load indicator 166 is between the handle 122 and the motor 118. FIG. 6 illustrates an example display of the load indicator 166, in which more sections 168 are illuminated as the load experienced by the cable puller 100 in pulling cable increases. The load indicator 166 may also include a temperature signal section 170 to indicate when a temperature of, for instance, the motor 118 or the battery pack 130 exceeds a threshold temperature.

Returning to FIG. 4, the battery pack 130 is attached to the handle housing in the battery receptacle 128 in an insertion direction that is parallel with a plane coincident with the base 106 of the motor housing 102. In some embodiments, the battery receptacle 128 forms an insertion direction that intersects the motor axis 104. In the illustrated embodiment, the insertion direction also intersects a controller 172, e.g., a printed circuit board, that is disposed in the handle housing 120 and is electrically connected to the battery receptacle 128 and the battery pack 130 when the battery pack 130 is engaged with the battery receptacle 128. The controller 172 is also electrically connected with the motor 118, the trigger 134, and the load indicator 166 in some embodiments. The controller 172 includes the control electronics for controlling the operation of the cable puller 100.

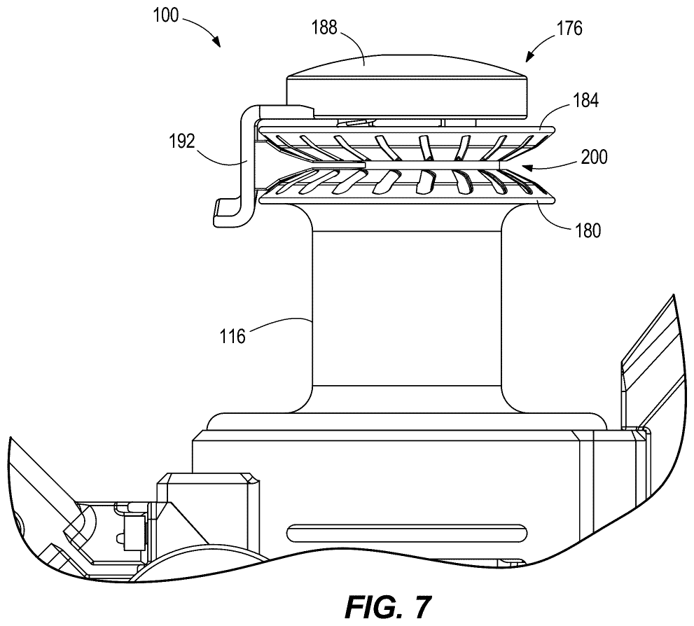

With reference to FIGS. 7 and 8, the cable puller 100 further includes a self-tailing mechanism 176 coupled to the capstan assembly 116. In other embodiments, the self-tailing mechanism 176 is removably coupled to the capstan assembly 116. The self-tailing mechanism 176 includes a bottom jaw or first jaw 180, a top jaw or second jaw 184, a stripper 188, and a finger or tab 192 coupled to the stripper 188. In the illustrated embodiment, the first jaw 180 is integrally connected to the capstan assembly 116. In other embodiments, the first jaw 180 may be removably coupled to the capstan assembly 116. The second jaw 184 is connected to the capstan assembly 116 by an interconnecting member 196 (FIG. 8). As such, the first jaw 180 and the second jaw 184 are coupled to the capstan assembly 116 for corotation about the motor axis 104. The first and second jaws 180, 184 define a gap 200 therebetween. A rope, used to pull cables and/or wires through conduits, is wrapped around the capstan assembly 116 and received within the gap 200. The second jaw 184 is movable in an upward direction or a downward direction relative to the capstan assembly 116 to adjust the size of the gap 200 according to a thickness of the rope.

The stripper 188 is coupled to the second jaw 184 and the tab 192 extends from the stripper 188. In the illustrated embodiment, the tab 192 is integrally formed with the stripper 188. In other embodiments, the tab 192 is formed as a separate piece that is removably coupled to the stripper 188. The stripper 188 is coupled to the second jaw 184 such that the stripper 188 and the tab 192 are not rotatable with the capstan assembly 116.

During operation, a user may grasp the handle 122 and depress the trigger 134 to actuate the motor 118. When the motor 118 is actuated, the capstan assembly 116 is driven to rotate about the motor axis 104. The rope is pulled through a conduit and then wrapped around the capstan assembly 116. The roller assembly 156 is also used to guide the rope in a desired direction as the cable puller 100 is being used to pull the rope. After the rope has been wrapped around the capstan assembly 116 multiple times, a portion of the rope is received within the gap 200 to be wrapped once around the self-tailing mechanism 176. As the rope is fed through the gap 200 during rotation of the capstan assembly 116, the self-tailing mechanism 176 is configured to reduce tension within the rope. The rope is then guided out of the gap 200 by the tab 192 and removed from the self-tailing mechanism 176. The rope is deposited into a pile that may be located next to the user. As such, the self-tailing mechanism 176 provides a safe working environment for the user as the cable puller 100 is pulling cables and/or wires through conduits.

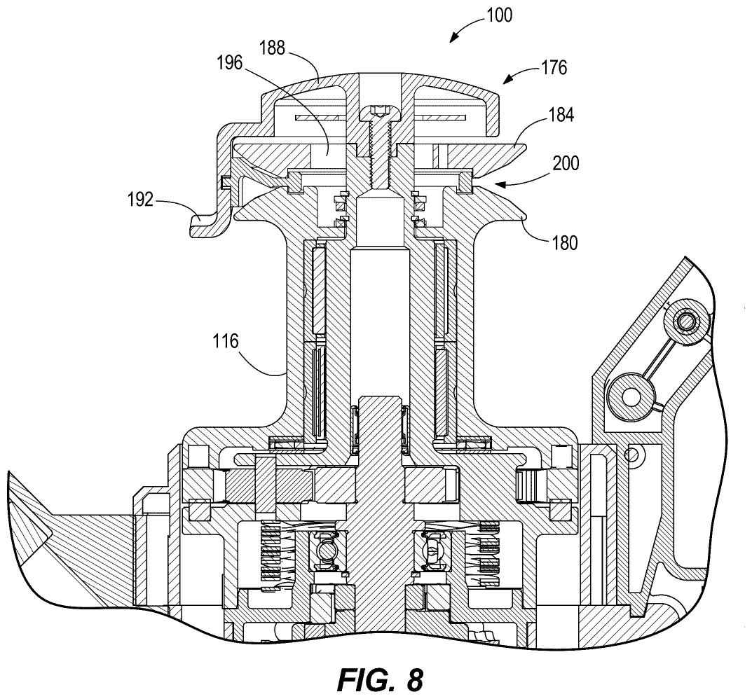

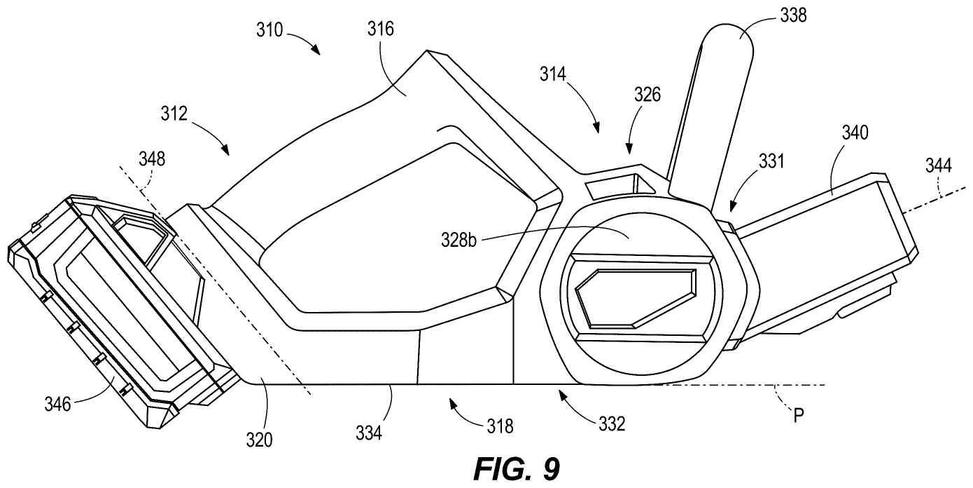

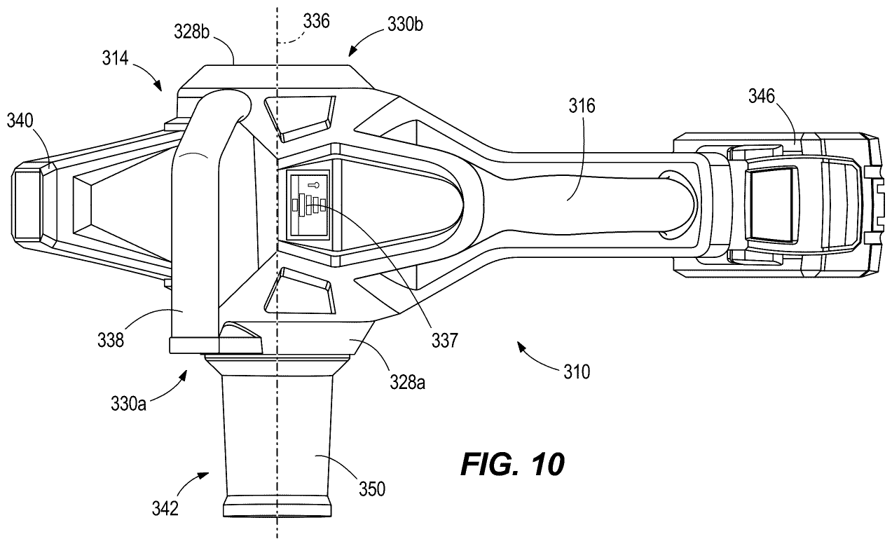

FIGS. 9 and 10 illustrate another cable puller 310 that is used to pull cables and/or wires through enclosed conduits. The cable puller 310 includes a housing 312 having a motor housing 314, a handle housing or primary handle 316 configured to be grasped by a user to easily transport the cable puller 310, a base 318, and a battery receptacle 320. The motor housing 314 has a top portion 326, first and second side portions 328a, 328b respectively formed on opposite ends 330a, 330b of the motor housing 314, a front portion 331, and a bottom portion 332 opposite the top portion 326. The base 318 and the bottom portion 332 of the motor housing 314, together form a bottom surface 334 of the housing 312 defining a plane P. The motor housing 314 defines a motor axis 336 extending longitudinally through the center of the motor housing 314 between the first and second ends 330a, 330b.

The primary handle 316 extends from the top portion 326 of the motor housing 314. The primary handle 316 has a load indicator 337 similar to the load indicator 166 of FIG. 6. The base 318 extends from the bottom portion 332 of the motor housing 314. The primary handle 316 and the base 318 are interconnected to each other by the battery receptacle 320. In the illustrated embodiment, the motor housing 314, the primary handle 316, the base 318, and the battery receptacle 320 are all integrally formed as a single housing such that the housing 312 is a single unitary structure. The housing 312 of the cable puller 310 is formed as a clamshell housing of two mirrored housing parts joined together. In other embodiments, the housing 312 may be formed as multiple components that may be coupled together. An auxiliary handle 338 is coupled to and extends outwardly from the top portion 326 of the motor housing 314 to be grasped by the user during operation and/or transportation of the cable puller 310.

The cable puller 310 further includes a boom support 340 and a capstan assembly 342. The boom support 340 is coupled to and extends outwardly from the front portion 331 of the motor housing 314. A boom axis 344 is defined by the boom support 340 and is obliquely oriented relative to the plane P. A boom (not shown), similar to the boom 150 of FIGS. 1-5, is disposed within the boom support 140 to thereby extend along the boom axis 344. The capstan assembly 342 is coupled to and extends outwardly from the first side portion 328a of the motor housing 314. As such, the capstan assembly 342 extends from the housing 312 along the motor axis 336. A motor (not shown) is disposed within the motor housing 314 and drives the capstan assembly 342 about the motor axis 336.

The battery receptacle 320 is removably engageable with a battery pack 346. In one example, the battery pack 346 includes one or more cell strings and each cell string includes a number of battery cells (e.g., 10) connected in series to provide a desired discharge output (e.g., nominal voltage [e.g., 20 V, 40 V, 60 V, 80 V, 130 V] and current capacity). The battery cells of the battery pack 346 are any rechargeable battery cell chemistry type, such as, for example, lithium (Li), lithium-ion (Li-ion), other lithium-based chemistry, nickel-cadmium (NiCd), nickel-metal hydride (NiMH), etc. The battery pack 346 is slidable along a battery axis 348 (shown in FIG. 9) in a first direction (or insertion direction) to be engaged with the battery receptacle 320 and in a second direction to be removed from the battery receptacle 320. As shown in FIG. 9, the battery axis 348 is obliquely oriented relative to the plane P. As such, the battery pack 346 is configured to supply power to the motor to drive the capstan assembly 342. The handle housing 120 includes a trigger (not shown) that is toggled to actuate the motor within motor housing 314.

With reference to FIG. 10, the capstan assembly 342 is illustrated. The capstan assembly 342 includes a capstan 350 and a jaw (not shown) removably coupled to the capstan 350. A rotational axis of the capstan 350 extends parallel to and colinear with the motor axis 336. The jaw is an interchangeable jaw configured to accommodate different rope sizes and/or types.

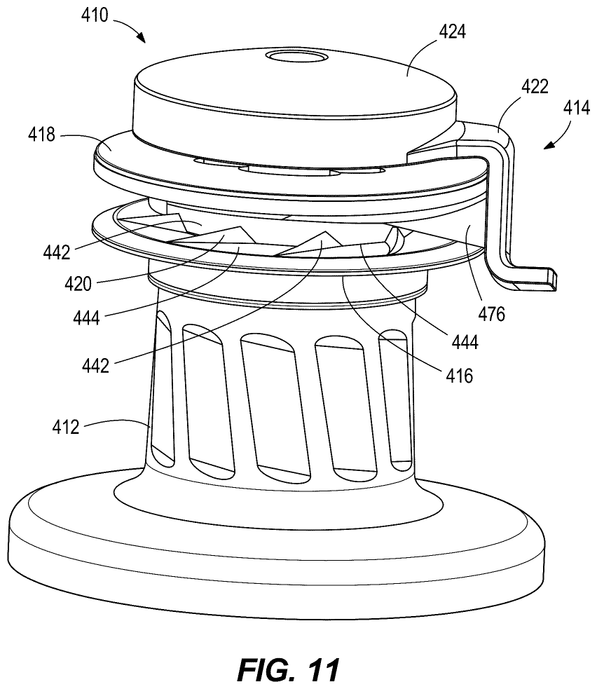

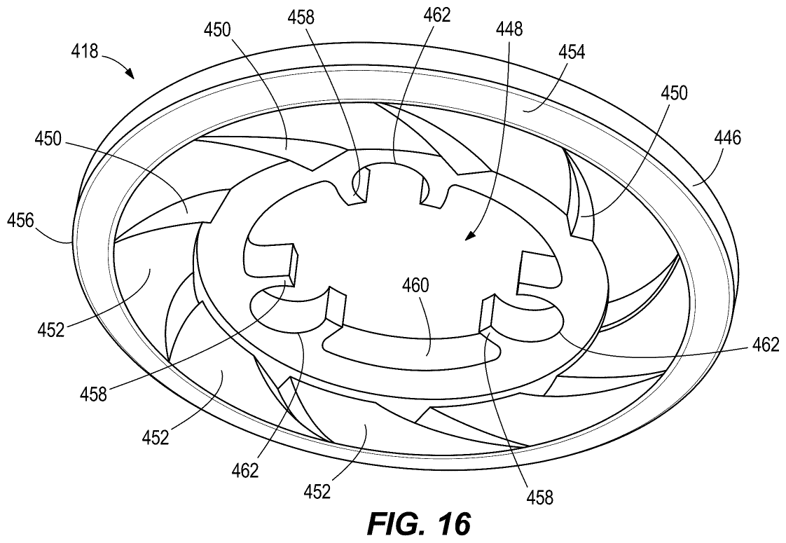

FIGS. 11-16 illustrate an alternative capstan assembly 410 that may be used with the cable puller 310. The illustrated capstan assembly 410 includes a capstan 412 and a self-tailing mechanism 414 coupled to the capstan 412. The capstan 412 is rotatably coupled to the motor housing 314 and configured to be driven by the motor within the motor housing 314. The self-tailing mechanism 414 includes a bottom jaw or first jaw 416, a top jaw or second jaw 418 oriented parallel to the first jaw 416, a stripper 420 disposed between the first and second jaws 416, 418, and a finger or tab 422 integrally formed with a cap 424. The parallel orientation of the second jaw 418 relative to the first jaw 416 allows the capstan assembly 410 to cooperate with ropes having various sizes due to a stiffness of the rope. When coupled to the motor housing 314 of the cable puller 310, a rotational axis of the capstan assembly 410 extends parallel to and colinear with the motor axis 336. In other embodiments, the capstan assembly 410 may be used with the cable puller 100.

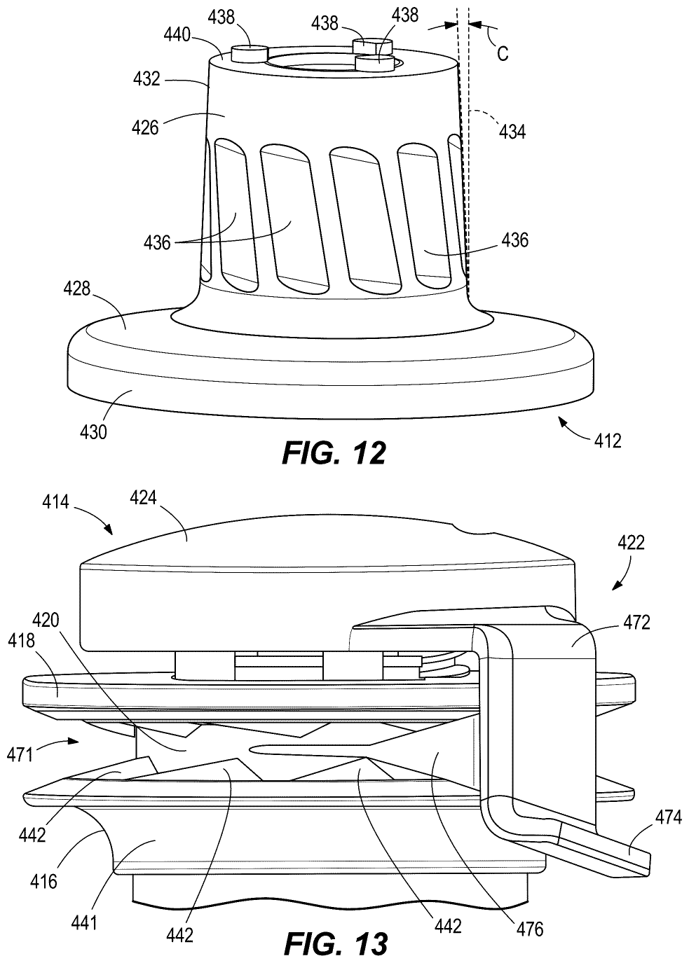

With reference to FIGS. 11 and 12, the capstan 412 includes a body 426, a flange 428 extending radially outward from the body 426, and a rim 430 extending from the flange 428. The body 426 of the capstan 412 has a cylindrical shape and a tapered configuration. An outer surface 432 of the body 426 is oriented at a capstan angle C relative to a body axis 434 that is parallel to the motor axis 336 of the cable puller 310. In the illustrated embodiment, the capstan angle C is approximately 2 degrees. In other embodiments, the capstan angle C may be larger or smaller. A plurality of grooves 436 is defined along the body 426 of the capstan 412. Each groove 436 is obliquely oriented relative to the body axis 434. Also, multiple protrusions 438 extend from a top end 440 of the body 426. When the capstan 412 is coupled to the motor housing 314 of the cable puller 310, the rim 430 is disposed within the motor housing 314 to couple the capstan 412 to the cable puller 310.

With reference to FIGS. 13, 14, and 15, the first jaw 416 is disposed on the top end 440 of the body 426 of the capstan 412. The protrusions 438 of the capstan 412 are coupled to the first jaw 416, and thereby couple the first jaw 416 to the capstan 412 for co-rotation. As such, the first jaw 416 is also rotatable about the motor axis 336. The first jaw 416 includes a body 441 having a circular shape and a plurality of ribs 442 formed along the body 441. Each rib 442 extends from the body 441 and has a spiral configuration. The ribs 442 are spaced from each other such that a respective flat section 444 (FIG. 11) is disposed between adjacent ribs 442.

With reference to FIGS. 13, 14, and 16, the second jaw 418 is also coupled to the capstan 412 for co-rotation. As such, the second jaw 418 is rotatable about the motor axis 336. The second jaw 418 includes a body 446 with a circular shape and an opening 448 defined at a central portion of the second jaw 418. Also, the second jaw 418 includes a plurality of ribs 450 formed along the body 446. Each rib 450 has a spiral configuration similar to the plurality of ribs 442 of the first jaw 416. The ribs 450 are spaced from each other such that a flat section 452, defined on the body 446 of the second jaw 418, is disposed between adjacent ribs 450. The second jaw 418 further includes a chamfer 454 formed on the body 446 and extending from a periphery 456 of the second jaw 418. In the illustrated embodiment, three brackets 458 are formed along a central surface 460 that defines the opening 448 of the second jaw 418. Each bracket 458 includes a recess 462 defined therein. In other embodiments, the second jaw 418 may include more than or less than three brackets 458.

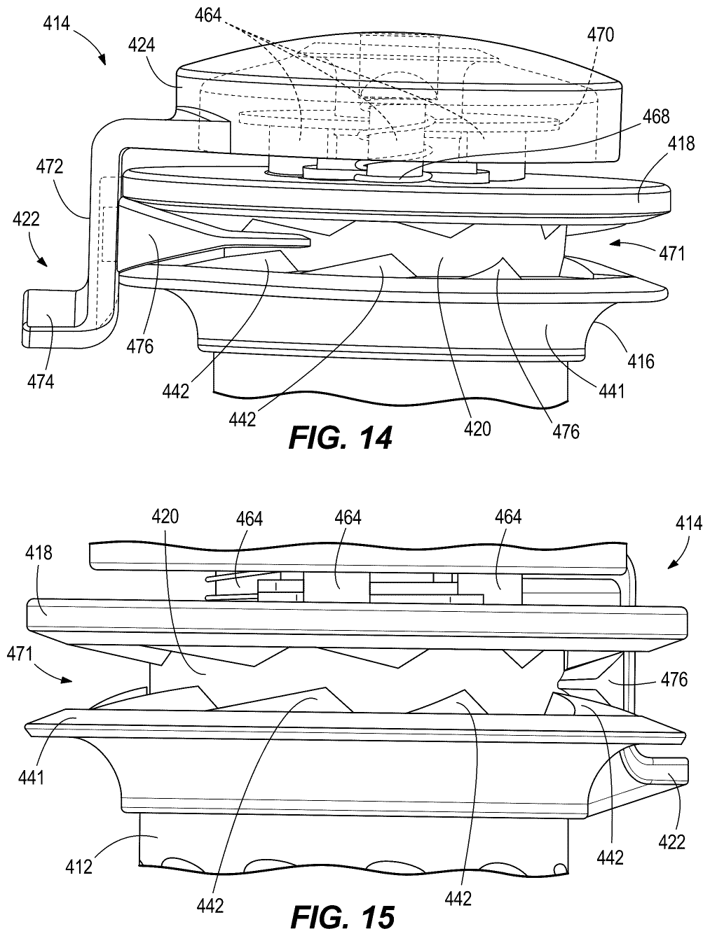

Moreover, the first jaw 416 includes multiple guide posts 464 positioned to extend through the opening 448 of the second jaw 418. At least a portion of each guide post 464 is arranged within the cap 424. A respective biasing member or spring 468 is arranged on each guide post 464 (illustrated embodiment only shows one spring 468) such that each spring 468 is disposed between the second jaw 416 and a plate 470 (FIG. 14) coupled to an end of each guide post 464. Each spring 468 is configured to bias the second jaw 416 in a downward direction towards the first jaw 416 to provide a clamping force onto a rope received between the first and second jaws 416, 418. The axial movement of the second jaw 418 is thereby controlled via the springs 468. As such, each spring 468 biases the second jaw 418 such that a fixed gap 471 is defined between the first and second jaws 416, 418. Each flat section 452 allows each spring 468 and each rib 450 to clamp onto a rope disposed within the fixed gap 471.

With reference to FIGS. 13 and 14, the cap 424 is disposed above the first and second jaws 416, 418. The tab 422 includes a first tab portion 472 extending outwardly from the cap 424 and a second tab portion 474 extending from the first tab portion 472 in a direction away from the capstan assembly 410. The second tab portion 474 has a sloped configuration and is configured to guide a rope between the jaws 416, 418 and into the gap 471. The cap 424 is fixedly coupled to the capstan 412 so that the cap 424 and the tab 422 are not rotatable with the capstan 412.

The stripper 420 includes a wedge 476 extending between the first and second jaws 416, 418. At least a portion of the wedge 476 is received within the tab 422 to thereby interconnect the stripper 420 with the tab 422. The stripper 420 is also fixedly coupled to the capstan 412 so that the stripper 420 is not rotatable with the capstan 412.

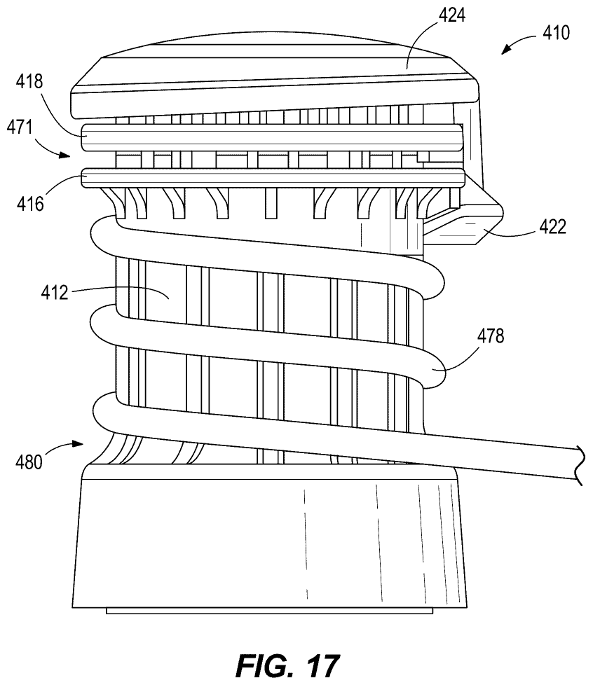

FIG. 17 illustrates the capstan assembly 410 wrapped with a rope 478 that is used to pull cables and/or wires through conduits and configured to be received within the gap 471. During operation, a user may grasp the handle 316 of the cable puller 310 and depress the trigger to actuate the motor. When the motor is actuated, the capstan assembly 410 is driven to rotate about the motor axis 336. The rope 478 is pulled through a conduit and then wrapped around the capstan assembly 410. The user wraps the rope 478 around the body 426 of the capstan 412 two or three times and starts the wrapping process at a bottom portion 480 of the capstan 412. Wrapping the rope 478 around the capstan 412 more will decrease a tension of the rope 478 due to Equation 1. Equation 1 may also be referred to as the capstan equation.

$${T}_{hold} = \frac{{T}_{load}}{{e}^{μ ∅}} \qquad Equation 1$$

T_{load} defines a tension of the rope 478 from a load applied to the rope 478. T_{hold} defines a tension of the rope 478 after the rope 478 has been wrapped around the capstan 412. μ defines a coefficient of friction between the rope 478 and the capstan 412. Ø defines a wrap angle between the rope 478 and the body 426 of the capstan 412.

Once the rope 478 is wrapped around the capstan 412, the user may then wrap the rope 478 around the tab 422, more specifically the second tab portion 474. As such, the second tab portion 474 guides the rope 478 between the jaws 416, 418 and into the gap 471. When the rope 478 is received within the gap 471, the rope 478 is wrapped once around the self-tailing mechanism 414. As the capstan 412 is rotated, the rope 478 is fed through the gap 471 so that the self-tailing mechanism 414 reduces tension within the rope 478. The chamfer 454 of the second jaw 418 is oriented to lead and guide the rope 478 into the gap 471 to make it easier to feed the rope 478 into the gap 471 during operation. Also, the spiral configuration of the plurality of ribs 450 of the second jaw 418 causes the rope 478 to be guided radially inwards so that the rope 478 is prevented from falling out of the gap 471. The rope 478 is then guided out of the gap 471 by the wedge 476 of the stripper 420 and removed from the self-tailing mechanism 414. The rope 478 is deposited into a pile that may be located next to the user.

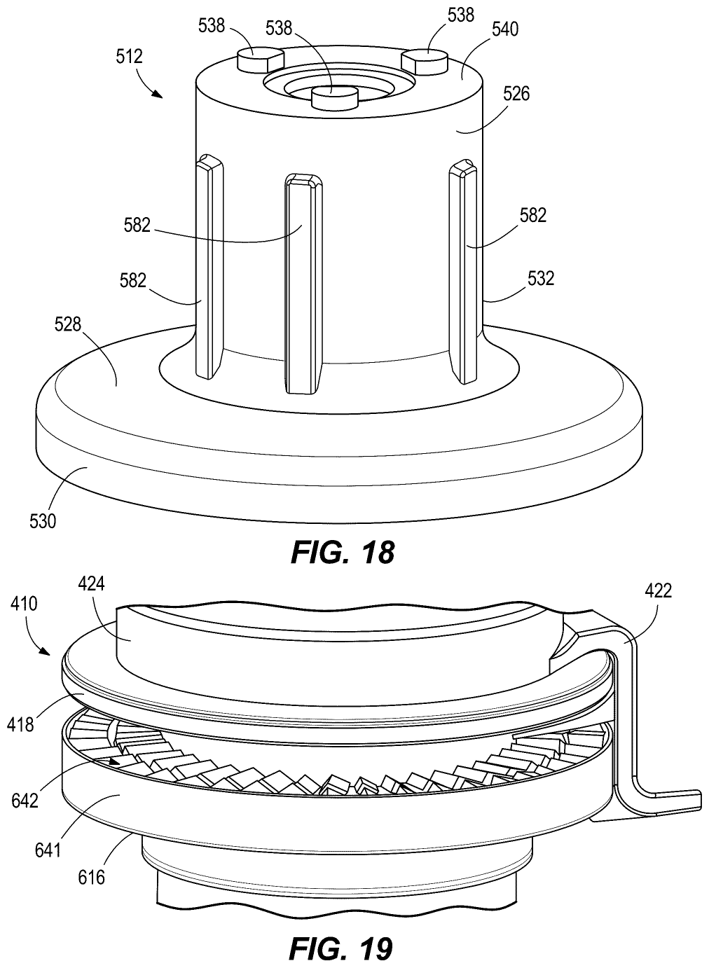

FIG. 18 illustrates another capstan 512 that may be incorporated with the capstan assembly 410 of FIGS. 11-17. The capstan 512 is similar to the capstan 412 of FIGS. 11 and 12; therefore, like structure will be identified by like reference number plus “100” and only the differences will be discussed hereafter.

The illustrated capstan 512 includes a body 526, a flange 528 coupled to and extending radially outward from the body 526, and a rim 530 extending from the flange 528. The body 526 of the capstan 512 has a cylindrical shape with a non-tapered configuration. In other words, an outer surface 532 of the body 526 is parallel to the motor axis 336 of the cable puller 310. The capstan 512 further includes a plurality of ribs 582 protruding from the outer surface 532 of the body 526. The ribs 582 are asymmetrically positioned along the body 526.

FIG. 19 illustrates another bottom jaw or first jaw 616 that may be incorporated with the capstan assembly 410 of FIGS. 11-17. The first jaw 616 is similar to the first jaw 416 of FIGS. 11 and 13-15; therefore, like structure will be identified by like reference number plus “200” and only the differences will be discussed hereafter.

The illustrated first jaw 616 includes a body 641 having a circular shape and a plurality of ribs 642 formed along the body 641. Each rib 642 has a beveled configuration. Also, the ribs 642 are not spaced from each other. Rather, the ribs 642 are closely arranged along the body 641 so that no flat section is defined between adjacent ribs 642.

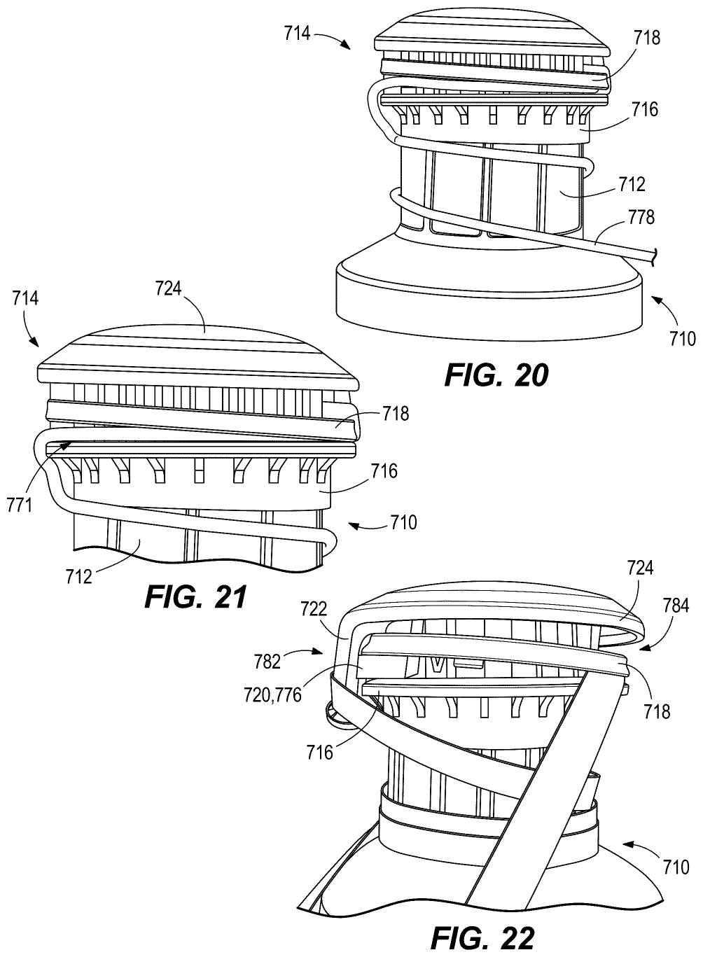

FIGS. 20-22 illustrate another capstan assembly 710. The capstan assembly 710 is similar to the capstan assembly 410 of FIGS. 11-16. Therefore, like structure will be identified by like reference number plus “300” and only the differences will be discussed hereafter.

The illustrated capstan assembly 710 includes a capstan 712 and a self-tailing mechanism 714 coupled to the capstan 712. The self-tailing mechanism 714 includes a bottom jaw or first jaw 716, a top jaw or second jaw 718, a stripper 720 disposed between the first and second jaws 716, 718, and a finger or tab 722 integrally formed with a cap 724. On a first side 782 of the self-tailing mechanism 714, adjacent a wedge 776 of the stripper 720, a gap 771 is defined between the first and second jaws 716, 718. On a second side 784 of the self-tailing mechanism 714, opposite the first side 782, the first and second jaws 716, 718 are oriented relative to each other such that at least a portion of the first jaw 716 is in contact with at least a portion of the second jaw 718. In other words, there is no clearance defined between the jaws 716, 718 on the second side 784 of the self-tailing mechanism 714. As such, the capstan assembly 710 is able to clamp onto small ropes (e.g., rope 778) such as, for example, a polyline rope.

The capstans 412, 512, 712 of FIGS. 11-22 may be used with any of the first jaws 416, 616, 716 of FIGS. 11, 13-15, 17, 19, and 20. The capstans 412, 512, 712 of FIGS. 11-22 may also be used with any of the second jaws 418, 718 of FIGS. 11 and 13-17. As such, various combinations of jaws and capstans can be provided for a cable puller.

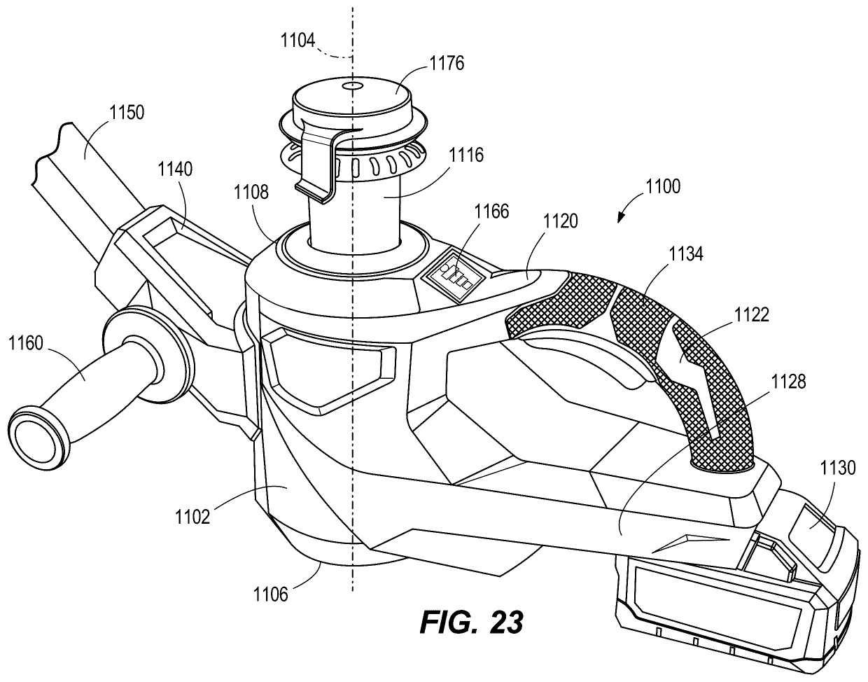

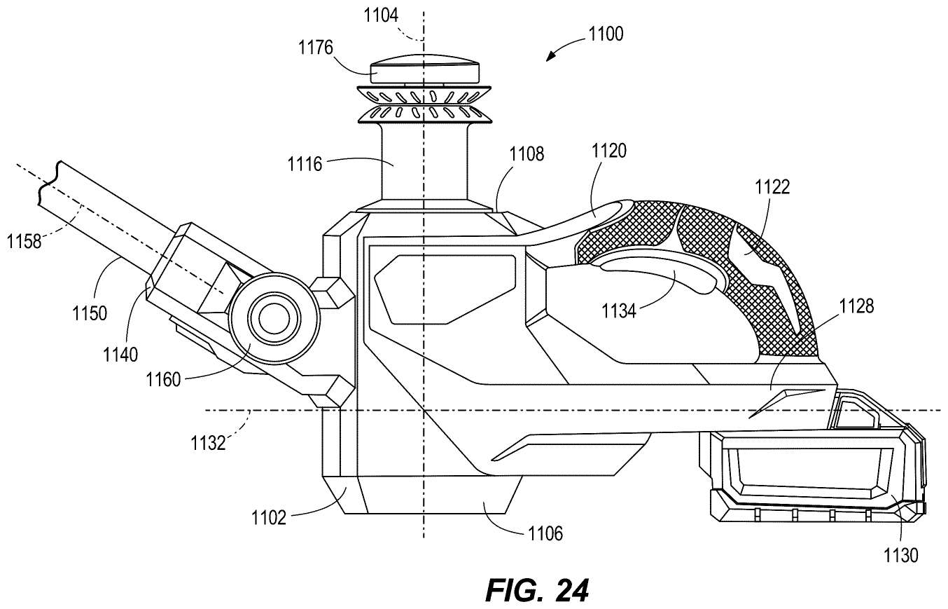

FIGS. 23 and 24 illustrate another cable puller 1100. The cable puller 1100 is similar to the cable puller 100 of FIGS. 1-8; therefore, like structure will be identified by like reference number plus “1000” and only the differences will be discussed hereafter.

The illustrated cable puller 1100 includes a central motor housing 1102 and a handle housing 1120 attached to the central motor housing 1102. The handle housing 1120 has a handle 1122 configured to be grasped by a user during operation and transportation of the cable puller 1100. The handle 1122 has a curvilinear shape. The handle housing 1120 also includes an elongated trigger 1134 having a curvilinear shape. The trigger 1134 is a long, ergonomically designed trigger that may be easily grasped by the user when operating the cable puller 1100.

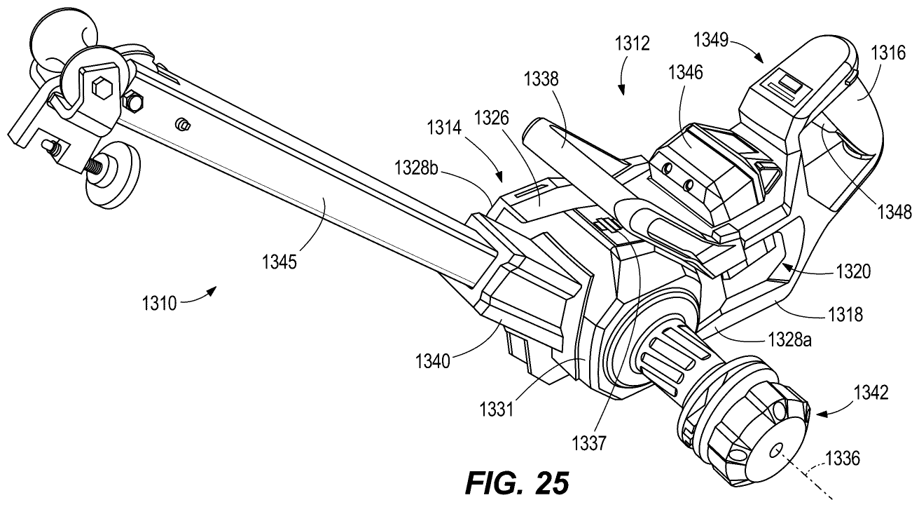

FIGS. 25-32 illustrate another cable puller 1310. The cable puller 1310 is similar to the cable puller 310 of FIGS. 9 and 10; therefore, like structure will be identified by like reference number plus “1000” and only the differences will be discussed hereafter.

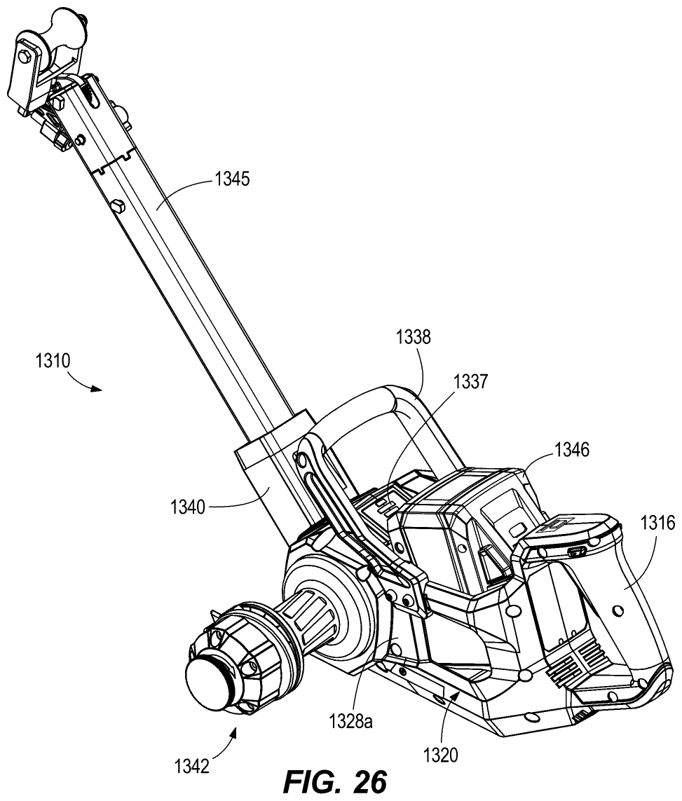

With reference to FIGS. 25 and 26, the illustrated cable puller 1310 includes a housing 1312 having a motor housing 1314, a handle housing or primary handle 1316 configured to be grasped by the user to easily transport the cable puller 1310, a base 1318, and a battery receptacle 1320. The motor housing 1314 has a top portion 1326, first and second side portions 1328a, 1328b formed opposite of each other, and a front portion 1331. The primary handle 1316 extends from a rear portion of the housing 1312. The primary handle 1316 is a generally a D-shaped handle. The battery receptacle 1320 is located at a central portion of the housing 1312 such that the battery receptacle 1320 is disposed between the motor housing 1314 and the primary handle 1316. In the illustrated embodiment, the motor housing 1314, the primary handle 1316, the base 1318, and the battery receptacle 1320 are all integrally formed as a single housing such that the housing 1312 is a single unitary structure. In other embodiments, the housing 1312 may be formed as multiple components that may be coupled together. The housing 1312 also has a load indicator 1337 similar to the load indicator 166 of FIG. 6 and an auxiliary handle 1338. The load indicator 1337 is located on the motor housing 1314. The auxiliary handle 1338 is coupled to and extends outwardly from the housing 1312 to be grasped by the user during operation and/or transportation of the cable puller 1310.

The cable puller 1310 further includes a boom support 1340 and a capstan assembly 1342. The boom support 1340 is coupled to and extends outwardly from the front portion 1331 of the motor housing 1314. A boom 1345, similar to the boom 150 of FIGS. 1-5, is disposed within the boom support 1340 to extend from the motor housing 1314. The capstan assembly 1342 is coupled to and extends outwardly from the first side portion 1328a of the motor housing 1314. As such, the capstan assembly 1342 extends from the housing 1312 along a motor axis 1336. A motor (not shown) is disposed within the motor housing 1314 and drives the capstan assembly 1342 about the motor axis 1336.

The battery receptacle 1320 is removably engageable with a battery pack 1346. In one example, the battery pack 1346 includes one or more cell strings and each cell string includes a number of battery cells (e.g., 10) connected in series to provide a desired discharge output (e.g., nominal voltage [e.g., 20 V, 40 V, 60 V, 80 V, 130 V] and current capacity). The battery cells of the battery pack 1346 are any rechargeable battery cell chemistry type, such as, for example, lithium (Li), lithium-ion (Li-ion), other lithium-based chemistry, nickel-cadmium (NiCd), nickel-metal hydride (NiMH), etc. As such, the battery pack 1346 is configured to supply power to the motor to drive the capstan assembly 1342. The primary handle 1316 includes a trigger 1348 that is toggled to actuate the motor within motor housing 1314. The trigger 1348 is a variable speed trigger configured to control an operating speed of the motor. The primary handle 1316 further includes a speed mode selector 1349 that allows the user to select a specific operating speed of the motor, such as a low operating speed or a high operating speed.

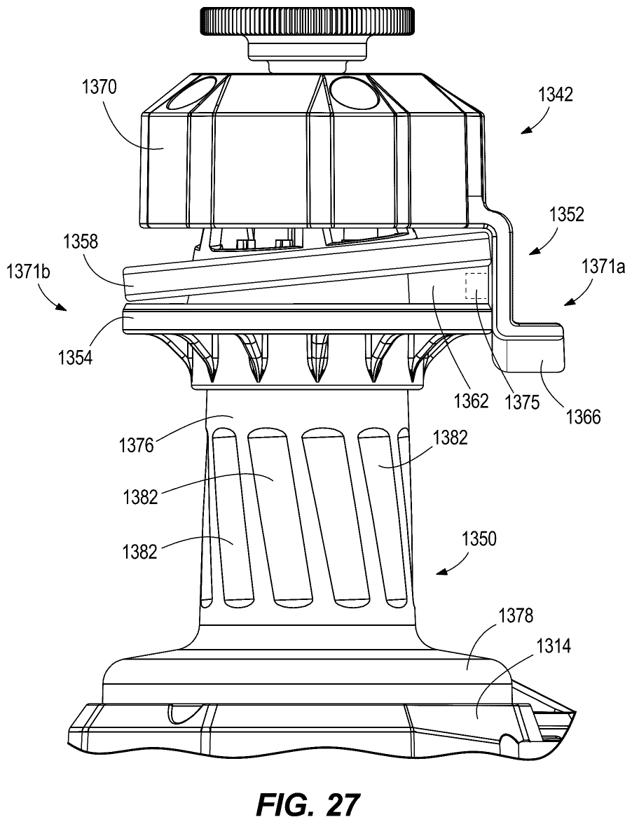

With reference to FIG. 27, the capstan assembly 1342 is illustrated and is similar to the capstan assembly 710 of FIGS. 20-22. The capstan assembly 1342 includes a capstan 1350 and a self-tailing mechanism 1352 coupled to the capstan 1350. The capstan 1350 is rotatably coupled to the motor housing 1314 and configured to be driven by the motor within the motor housing 1314. The self-tailing mechanism 1352 includes a bottom jaw or first jaw 1354, a top jaw or second jaw 1358, a stripper wedge or a rope guide 1362 disposed between the first and second jaws 1354, 1358, and a finger or tab 1366 integrally formed with a cap 1370 and disposed on a first side 1371a of the self-tailing mechanism 1352. When coupled to the motor housing 1314 of the cable puller 1310, a rotational axis of the capstan assembly 1342 extends parallel to and colinear with the motor axis 1336. In other embodiments, the capstan assembly 1342 may be used with the cable puller 100 of FIGS. 1-8 and the cable puller 310 of FIGS. 9 and 10.

The rope guide 1362 extends to a central portion of the capstan assembly 1342 (e.g., a central wall 1372 of the capstan assembly 1342) and has a curved configuration for routing the rope off of the self-tailing mechanism 1352 in a direction away from the jaws 1354, 1358. More specifically, the rope guide 1362 has a concave face 1373 for guiding the rope off the self-tailing mechanism 1352 to prevent the rope from becoming entangled between the jaws 1354, 1358 and the rope guide 1362. For ropes with high stiffness, the rope guide 1362 may have a plurality of fingers that extend into grooves defined within the jaws 1354, 1358. Also, there are no spaces respectively defined between the rope guide 1362 and the jaws 1354, 1358. The tab 1366 has a projection 1375 (FIG. 27) extending therefrom to be received within a groove 1374 defined within the rope guide 1362. As such, the tab 1366 may be used to guide the rope between the jaws 1354, 1358 during operation of the cable puller 1310.

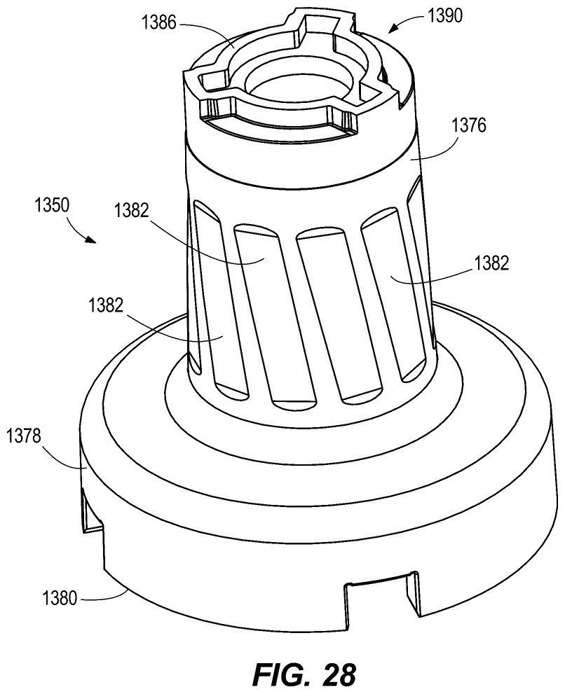

With reference to FIG. 28, the capstan 1350 includes a body 1376, a flange 1378 extending radially outward from the body 1376, and a rim 1380 extending from the flange 1378. The body 1376 of the capstan 1350 has a cylindrical shape and a plurality of grooves 1382 defined therein. The grooves 1382 are obliquely oriented relative to rotational axis of the capstan assembly 1342. Also, has a protrusion 1386 extending from a top end 1390 of the body 1376. When the capstan 1350 is coupled to the motor housing 1314 of the cable puller 1310, a portion of the rim 1380 is disposed within the motor housing 1314 to couple the capstan 1350 to the cable puller 1310.

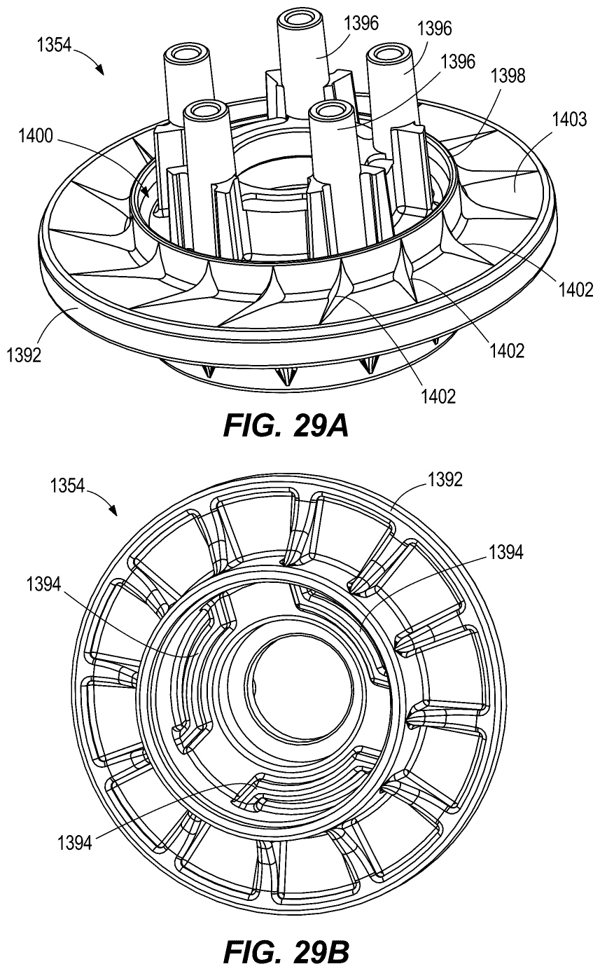

With reference to FIGS. 29A and 29B, the first jaw 1354 includes a body 1392 having a circular shape, multiple protrusions 1394 formed along a bottom portion of the first jaw 1354, a first plurality of projections 1396 extending from the body 1392 in a direction parallel to the motor axis 1336, and a collar 1398 surrounding the first plurality of projections 1396. A gap 1400 is defined between the first plurality of projections 1396 and the collar 1398. The protrusions 1394 of the first jaw 1354 cooperates with the protrusion 1386 of the capstan 1350 to thereby couple the first jaw 1354 to the capstan 1350 for co-rotation. As such, the first jaw 1354 is also rotatable about the motor axis 1336. The first jaw 1354 also includes a plurality of ribs 1402 formed along a flat surface 1403 of the body 1392 such that the ribs 1402 are spaced from each other. Each rib 1402 extends from the body 1392 and has a spiral configuration.

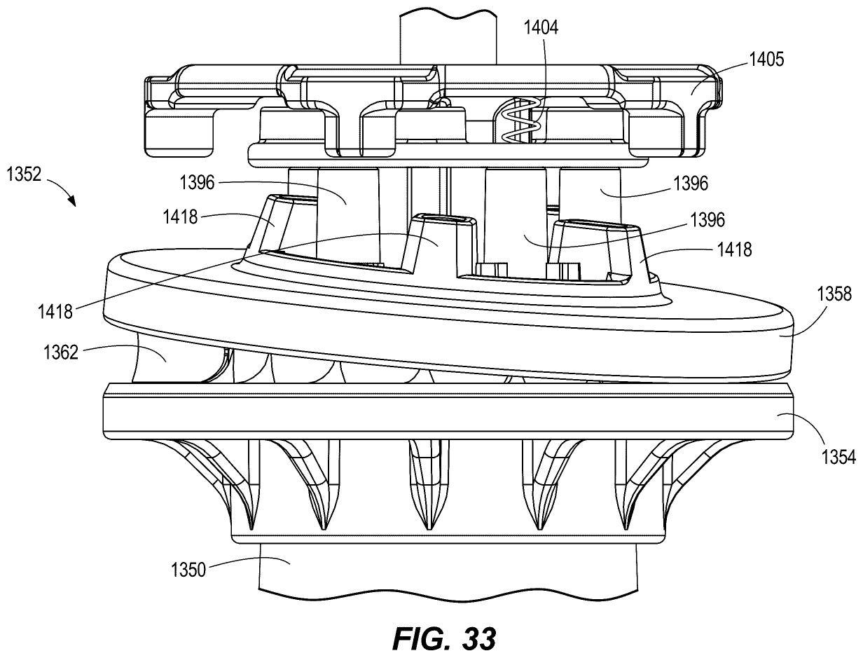

With reference to FIG. 33, one or more biasing members or springs 1404 (only one spring 1404 is shown in the illustrated embodiment) are respectively arranged between each projection 1396 of the first jaw 1354 and a plate 1405 fixedly coupled to the cap 1370. The springs 1404 provide a minimum spring force to the first and second jaws 1354, 1358 to clamp onto a portion of the rope that extends between the jaws 1354, 1358. In other embodiments, other spring line members may be used instead of the springs 1404. To determine the minimum spring force, Equation 2 must be used to identify how much force the jaws 1354, 1358 must apply to clamp on the rope. Equation 2 may also be referred to as another capstan equation.

$${T}_{load} = {T}_{hold} {e}^{μφ} \qquad Equation 2$$

T_{toad} defines a peak force applied to the rope by the capstan assembly 1342. T_{hold} defines the force applied by the jaws 1354, 1358 to clamp onto the rope. μ defines a coefficient of friction between the rope and the capstan 1350. φ defines a wrap angle between the rope and the body 1376 of the capstan 1350. The wrap angle is measured in radians (e.g., the rope wrapped around the capstan 412 once is equivalent to 2π). T_{hold} may then be inputted into Equation 3 to determine the minimum spring. Equation 3 may also be referred to as the friction equation.

$$f = μ N \qquad Equation 3$$

f typically defines a frictional force. However, in this scenario, a value of T_{hold} may be inputted into Equation 3 in the place of the frictional force f to determine the minimum spring. μ defines a coefficient of friction between the rope and the jaws 1354, 1358. N defines a spring force or the minimum spring force of the springs 1404.

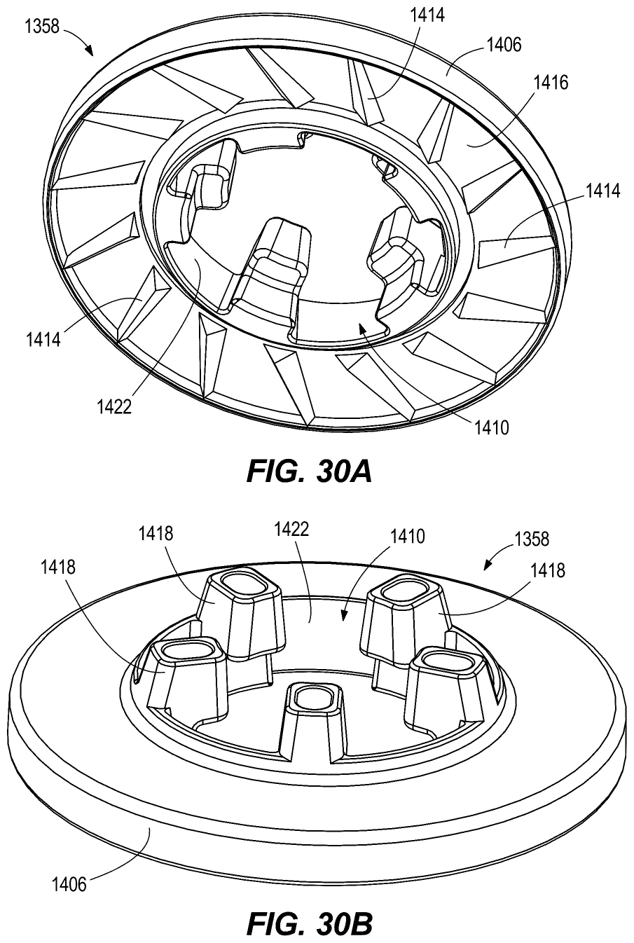

With reference to FIGS. 30A and 30B, the second jaw 1358 is also coupled to the capstan 1350 for co-rotation such that the second jaw 1358 is rotatable about the motor axis 1336. The second jaw 1358 includes a body 1406 with a circular shape and an opening 1410 defined at a central portion of the second jaw 1358. Also, the second jaw 1358 includes a plurality of ribs 1414 formed along a flat surface 1416 of the body 446 such that the ribs 1414 are spaced from each other. Each rib 1414 has a spiral configuration similar to the plurality of ribs 1402 of the first jaw 1354. The ribs 1402, 1414 improve a clamp function of the first and second jaws 1354, 1358 when a thick and stiff rope is used. In other embodiments, the ribs 1402 may be omitted such that each jaw 1354, 1358 only has a smooth flat surface configured to contact the rope. Having smooth flat surfaces formed on the jaws 1354, 1358 can reduced friction between the rope and the jaws 1354, 1358. The second jaw 1358 further includes a second plurality of projections 1418 extending from a central surface 1422 that defines the opening 1410 of the second jaw 1358.

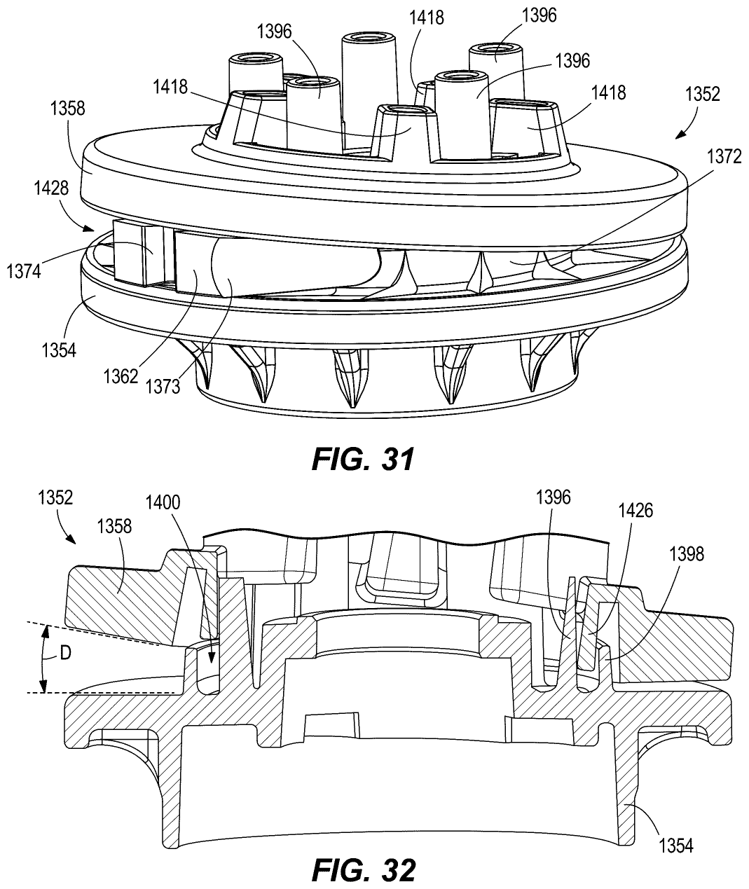

With reference to FIGS. 31 and 32, the first jaw 1354 and the second jaw 1358 are illustrated. When the self-tailing mechanism 1352 is assembled, the first plurality of projections 1396 of the first jaw 1354 extend through the opening 1410 of the second jaw 1358 such that each projection 1396 is arranged between adjacent projections of the second plurality of projections 1418. A flange 1426 on the second jaw 1358 is configured to be received within the gap 1400 of the first jaw 1354 to permit axial movement of the second jaw 1358 relative to the first jaw 1354. The first and second plurality of projections 1396, 1418 cooperate with each other to guide the axial movement of the second jaw 1358 relative to the first jaw 1354. The axial movement of the second jaw 1358 thereby defines a variable gap 1428 between the first and second jaws 1354, 1358, in which a portion of the rope is received when wrapped around the capstan assembly 1342.

The variable gap 1428 defines an angle D between the flat surface 1403 of the first jaw 1354 and the flat surface 1416 of the second jaw 1358 such that the jaws 1354, 1358 contact each other to provide a closed configuration at a second side 1371b of the self-tailing mechanism 1352 opposite the first side 1371a. For clarity, the ribs 1402, 1414 are omitted from FIG. 32 to clearly show the angle D of the variable gap 1428. The closed configuration of the jaws 1354, 1358 at the second side 1371b of the self-tailing mechanism 1352 allows the jaws 1354, 1358 to clamp onto a rope passing through the variable gap 1428.

The angle D of the variable gap 1428 varies with respect to a diameter of a rope arranged between the first jaw 1354 and the second jaw 1358 to accommodate ropes with different diameters because certain ropes may or may not have a round configuration. As such, the flat surfaces 1403, 1416 of the jaws 1354, 1358 gradually become parallel to each other when the diameter of the rope increases. Also, the angle D of the variable gap 1428 allows the rope to be released along the first side 1371a of the self-tailing mechanism 1352 such that the portion of the rope is no longer coupled to the capstan 1350 after one full rotation of the capstan 1350.

When the diameter of the rope decreases, the variable gap 1428 may form a V-shape. As such, it is essential for the jaws 1354, 1358 to have the closed configuration at the second side 1371b of the self-tailing mechanism 1352 when operating the cable puller 1310 to pull a small-diameter rope (e.g., a poly line or a mule tape) through a conduit. The closed configuration of the jaws 1354, 1358 ensures that the rope is wrapped properly around the self-tailing mechanism 1352. In addition, the jaws 1354, 1358 are self-adjustable during operation of the cable puller 1310.

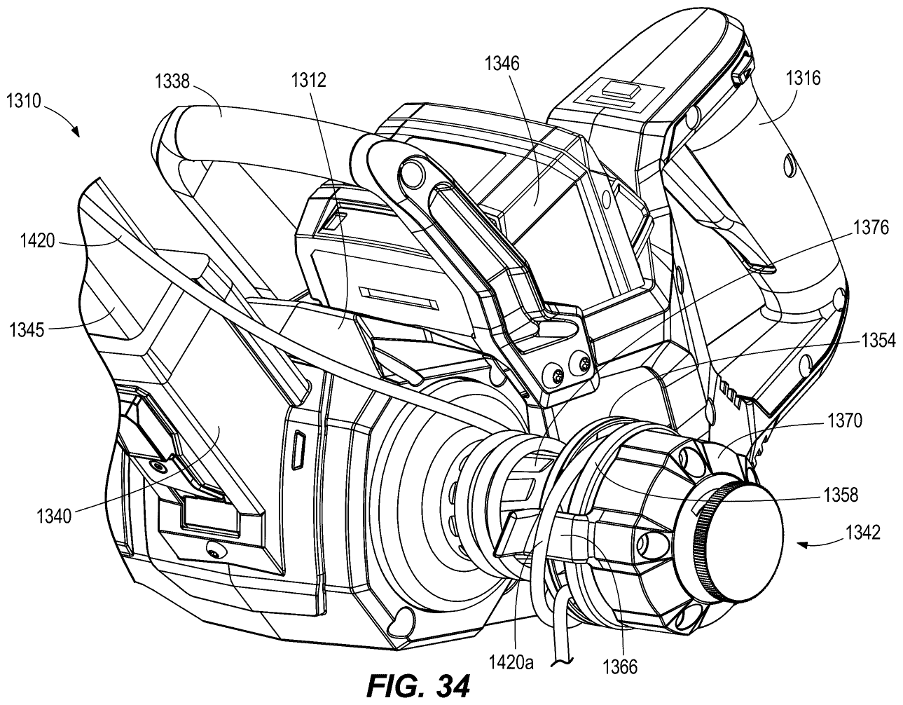

FIG. 34 illustrates a rope 1420 coupled to the cable puller 1310 during operation. When the motor is actuated, the capstan assembly 1342 is driven to rotate about the motor axis 1336. The rope 1420 is pulled through a conduit and then wrapped around the body 1376 of the capstan 1350 to create enough friction between the rope 1420 and the body 1376 for pulling the rope 1420 through the conduit. After the rope 1420 has been wrapped around the body 1376 multiple times, the rope 1420 is placed along the tab 1366 to be fed into the variable gap 1428 to be disposed between the jaws 1354, 1358. Since there are no spaces respectively defined between the rope guide 1362 and the jaws 1354, 1358, the rope 1420 is able to bypass the rope guide 1362 and be fed into the variable gap 1428. A portion of the rope 1420a is then received within the variable gap 1428 to be wrapped once around the self-tailing mechanism 1352. As the portion of the rope 1420a is fed through the variable gap 1428 during rotation of the capstan assembly 1342, the self-tailing mechanism 1352 is configured to reduce tension within the rope 1420.

After the portion of the rope 1420a passes the second side 1371b of the self-tailing mechanism 1352 and the area in which the jaws 1354, 1358 contact each other, the portion of the rope 1420a eventually falls out of the self-tailing mechanism 1352 due to gravity pulling the portion of the rope 1420a down and out of the jaws 1354, 1358. From the second side 1371b to the first side 1371a of the self-tailing mechanism 1352, the jaws 1354, 1358 separate from each other to form the V-shaped variable gap 1428 and form an opened configuration at the first side 1371a. As such, the open configuration of the jaws 1354, 1358 permits the portion of the rope 1420a to be released at the first side 1371a of the self-tailing mechanism 1352. If needed, the rope guide 1362 will eject the portion of the rope 1420a from the self-tailing mechanism 1352 if the rope 1420 has not fallen out of the self-tailing mechanism 1352 by itself. After failing out of the self-tailing mechanism 1352, the portion of the rope 1420a is deposited into a pile that may be located next to the user.

Although the disclosure has been described in detail with reference to certain preferred embodiments, variations and modifications exist within the scope and spirit of one or more independent aspects of the disclosure as described.

Various features of the disclosure are set forth in the following claims.

1. A cable puller comprising:
a motor housing:
a motor disposed in the motor housing, the motor rotating about a motor axis:
a capstan assembly rotationally driven by the motor about the motor axis:
a handle housing coupled to the motor housing, the handle housing including a battery receptacle for removably receiving a rechargeable battery pack: and
a boom coupled to the motor housing opposite the handle housing.

2. The cable puller of claim 1, wherein the motor housing further includes a plurality of gears disposed therein, the plurality of gears driven by the motor and driving the capstan assembly.

3. The cable puller of claim 1, wherein the handle housing forms a handle, and a plane crosses through the capstan assembly, the motor, and the handle.

4. The cable puller of claim 3, wherein the plane further crosses through the boom.

5. The cable puller of claim 1, wherein the battery receptacle is configured to receive the rechargeable battery pack in an insertion direction, the insertion direction being perpendicular to the motor axis.

6. The cable puller of claim 1, wherein the boom extends along a boom axis, and the boom axis and the motor axis form a boom angle therebetween, the boom angle being greater than or equal to thirty degrees.

7. The cable puller of claim 6, wherein the boom angle is less than or equal to sixty degrees.

8. The cable puller of claim 7, wherein the boom angle is greater than or equal to thirty-five degrees and less than or equal to fifty-five degrees.

9. The cable puller of claim 8, wherein the boom angle is greater than or equal to forty degrees and less than or equal to fifty degrees.

10. The cable puller of claim 9, wherein the boom angle is forty-five degrees.

11. A cable puller comprising:
a handle housing including a battery receptacle for removably receiving a rechargeable battery pack:
a motor housing coupled to the handle housing and including a motor disposed therein, the motor housing further including a base for engaging a support surface:
a capstan assembly disposed on an end of the motor housing opposite the base, the capstan assembly configured to be driven by the motor; and
a boom coupled to the motor housing opposite the handle housing.

12. The cable puller of claim 11, wherein the handle housing and the boom are coupled to the motor housing between the base and the end of the motor housing opposite the base.

13. The cable puller of claim 12, wherein the motor housing is generally cylindrical.

14. The cable puller of claim 11, further comprising a circuit board disposed in the handle housing.

15. The cable puller of claim 14, wherein the circuit board is disposed between the battery receptacle and the motor housing.

16. The cable puller of claim 11, further comprising a gear assembly disposed between the motor and the capstan assembly.

17. The cable puller of claim 11, wherein the motor rotates about a motor axis that extends through the base, the capstan assembly configured to rotate about the motor axis.

18. The cable puller of claim 11, wherein each of the handle housing, the boom, and the capstan assembly extends beyond the motor housing in a direction away from the base.

19. The cable puller of claim 11, further comprising a load indicator disposed on the handle housing.

20. The cable puller of claim 11, wherein the battery receptacle is configured to receive the rechargeable battery pack along an insertion direction, and the base is coincident with a plane that is parallel with the insertion direction.

21.-36. (canceled)
